(19) United States
(12) Patent Application Publication
(10) Pub. No.: US 2019/0112685 A1
(43) Pub. Date: Apr. 18, 2019

(54) METHOD OF PRODUCING GRAIN-ORIENTED ELECTRICAL STEEL SHEET

(71) Applicant: JFE STEEL CORPORATION, Chiyoda-ku Tokyo (JP)

(72) Inventors: Masanori TAKENAKA, Chiyoda-ku, Tokyo (JP); Yasuyuki HAYAKAWA, Chiyoda-ku, Tokyo (JP); Takeshi IMAMURA, Chiyoda-ku, Tokyo (JP); Yuiko EHASHI, Chiyoda-ku, Tokyo (JP)

(73) Assignee: JFE STEEL CORPORATION, Chiyoda-ku Tokyo (JP)

(21) Appl. No.: 15/774,370

(22) PCT Filed: Nov. 30, 2016
(86) PCT No.: PCT/JP2016/085616

§ 371 Date: May 8, 2018

(30) Foreign Application Priority Data
Dec. 4, 2015 (JP) 2015-237995

(51) Int. Cl. C21D 8/12; C21D 6/00; H01F 1/147; C22C 38/00; C22C 38/02; C22C 38/04; C22C 38/06; C22C 38/60

(52) U.S. Cl. CPC C21D 8/1272; C21D 8/1255; C21D 8/1261; C21D 8/1266; C21D 8/1283; C21D 6/008; C21D 2201/05; C22C 38/001; C22C 38/008; C22C 38/02; C22C 38/04; C22C 38/06; C22C 38/60; H01F 1/147

(57) ABSTRACT

A grain-oriented electrical steel sheet has magnetic properties improved over conventional grain-oriented electrical steel sheets. A method of producing a grain-oriented electrical steel sheet comprises: heating a steel slab at 1300° C. or less, the steel slab having a chemical composition containing C, Si, Mn, acid-soluble Al, S and/or Se, Sn and/or Sb, N, and a balance being Fe and inevitable impurities; subjecting the steel slab to hot rolling to obtain a hot rolled steel sheet; subjecting the hot rolled steel sheet to cold rolling once, or twice or more with intermediate annealing performed therebetween, to obtain a cold rolled steel sheet with a final sheet thickness; subjecting the cold rolled steel sheet to primary recrystallization annealing; applying an annealing separator to a surface of the cold rolled steel sheet after the primary recrystallization annealing; and then subjecting the cold rolled steel sheet to secondary recrystallization annealing.

### TECHNICAL FIELD

The present disclosure relates to a method of producing a grain-oriented electrical steel sheet having crystal grains of steel with the {110} plane in accord with the sheet plane and the <001> orientation in accord with the rolling direction, in Miller indices.

### BACKGROUND

A grain-oriented electrical steel sheet is a soft magnetic material mainly used as an iron core material of an electrical device such as a transformer or a generator, and has crystal texture in which the <001> orientation which is the easy magnetization axis of iron is highly aligned with the rolling direction of the steel sheet. Such texture is formed through secondary recrystallization of preferentially causing the growth of giant crystal grains in the (110)[001] orientation which is called Goss orientation, when secondary recrystallization annealing is performed in the process of producing the grain-oriented electrical steel sheet.

A conventional process for producing such a grain-oriented electrical steel sheet is as follows. A slab containing about 3 mass % Si and an inhibitor component such as MnS, MnSe, and AlN is heated at a temperature exceeding 1300° C. to dissolve the inhibitor component. The slab is then hot rolled, and optionally hot band annealed. The sheet is then cold rolled once, or twice or more with intermediate annealing performed therebetween, to obtain a cold rolled sheet with a final sheet thickness. The cold rolled sheet is then subjected to primary recrystallization annealing in a wet hydrogen atmosphere, to perform primary recrystallization and decarburization. After this, an annealing separator mainly composed of magnesia (MgO) is applied to the primary recrystallization annealed sheet, and then final annealing is performed at 1200° C. for about 5 h to develop secondary recrystallization and purify the inhibitor component (for example, U.S. Pat. No. 1,965,559 A (PTL 1), JP S40-15644 B2 (PTL 2), JP S51-13469 B2 (PTL 3)).

As mentioned above, the grain-oriented electrical steel sheet is conventionally produced by the technique of containing a precipitate (inhibitor component) such as MnS, MnSe, and AlN in the slab stage, heating the slab at a high temperature exceeding 1300° C. to dissolve the inhibitor component, and causing fine precipitation in a subsequent step to develop secondary recrystallization.

Thus, high-temperature slab heating exceeding 1300° C. is necessary in the conventional grain-oriented electrical steel sheet production process, which requires very high production cost. The conventional process therefore has a problem of being unable to meet the recent demands to reduce production costs.

To solve this problem, for example, JP 2782086 B2 (PTL 4) proposes a method of containing acid-soluble Al (sol.Al) in an amount of 0.010% to 0.060% and, while limiting slab heating to low temperature, performing nitriding in an appropriate nitriding atmosphere in a decarburization annealing step so that (Al, Si)N is precipitated and used as an inhibitor in secondary recrystallization.

Here, (Al, Si)N disperses finely in the steel, and functions as an effective inhibitor. In the steel sheet after subjection to the nitriding treatment by the above-mentioned production method, a precipitate (Si₃N₄ or (Si, Mn)N) mainly containing silicon nitride is formed only in the surface layer. In the subsequent secondary recrystallization annealing, the precipitate mainly containing silicon nitride changes to Al-containing nitride ((Al, Si)N or AlN) which is thermodynamically more stable. Here, according to Y. Ushigami et al. “Precipitation Behaviors of Injected Nitride Inhibitors during Secondary Recrystallization Annealing in Grain Oriented Silicon Steel” Materials Science Forum Vols. 204-206 (1996) pp. 593-598 (NPL 1), Si₃N₄ present in the vicinity of the surface layer dissolves during heating in the secondary recrystallization annealing, whereas nitrogen diffuses into the steel and, when the temperature exceeds 900° C., precipitates as Al-containing nitride approximately uniform in the sheet thickness direction, with it being possible to obtain grain growth inhibiting capability (inhibition effect) throughout the sheet thickness. With this technique, the same amount and grain size of precipitate can be obtained in the sheet thickness direction relatively easily, as compared with the precipitate dispersion control using high-temperature slab heating.

Meanwhile, a technique of developing secondary recrystallization without containing any inhibitor component in the slab is also under study. For example, JP 2000-129356 A (PTL 5) describes a technique (inhibitorless method) that enables secondary recrystallization without containing any inhibitor component.

### CITATION LIST

### Patent Literatures

PTL 1: US 1965559 A

PTL 2: JP S40-15644 B2

PTL 3: JP S51-13469 B2

PTL 4: JP 2782086 B2

PTL 5: JP 2000-129356 A

### Non-Patent Literature

NPL 1: Y. Ushigami et al. “Precipitation Behaviors of Injected Nitride Inhibitors during Secondary Recrystallization Annealing in Grain Oriented Silicon Steel” Materials Science Forum Vols. 204-206 (1996) pp. 593-598

### SUMMARY

### Technical Problem

The inhibitorless method does not require high-temperature slab heating, and so can produce the grain-oriented electrical steel sheet at low cost. However, due to the absence of the inhibitor component, normal grain growth (primary recrystallized grain growth) inhibiting capability is insufficient, which causes poor orientation of Goss grains growing during secondary recrystallization. This results in degradation of the magnetic properties of the product as compared with a high-temperature slab heated material.

It could therefore be helpful to provide a method of producing a grain-oriented electrical steel sheet at low cost with high productivity without requiring high-temperature slab heating, which enhances the normal grain growth inhibiting capability and sharpens the orientation of Goss grains growing during secondary recrystallization to thus improve the magnetic properties.

### Solution to Problem

We made intensive studies to solve the problems stated above.

As a result, we discovered that the normal grain growth inhibiting capability can be obtained even with slab heating in a low temperature region of 1300° C. or less, by mutually regulating the contents of component elements sol.Al, S, Se, Sn, and Sb in minute amount regions below their conventionally recognized contents for functioning as inhibitors.

We also discovered that the normal grain growth inhibiting capability can be further enhanced and the magnetic properties can be further improved by: applying nitriding treatment in a subsequent step to cause not AlN but silicon nitride (Si₃N₄) to precipitate and function to inhibit normal grain growth; and adding, to an annealing separator applied to the steel sheet before secondary recrystallization annealing, one or more selected from sulfide, sulfate, selenide, and selenite to function to inhibit normal grain growth immediately before secondary recrystallization. Hence, the present disclosure makes it possible to industrially produce a grain-oriented electrical steel sheet having magnetic properties equivalent to those of a high-temperature slab heated material, by a method of producing a grain-oriented electrical steel sheet at low cost with high productivity without requiring high-temperature slab heating.

We thus provide:

1. A method of producing a grain-oriented electrical steel sheet, the method comprising: heating a steel slab at 1300° C. or less, the steel slab having a chemical composition containing (consisting of), in mass %, C in an amount of 0.002% or more and 0.080% or less, Si in an amount of 2.00% or more and 8.00% or less, Mn in an amount of 0.02% or more and 0.50% or less, acid-soluble Al in an amount of 0.003% or more and less than 0.010%, S and/or Se in an amount of 0.005% or more and 0.010% or less in total, Sn and/or Sb in an amount of 0.005% or more and 1.0% or less in total, N in an amount of less than 0.006%, and a balance being Fe and inevitable impurities; subjecting the steel slab to hot rolling to obtain a hot rolled steel sheet; subjecting the hot rolled steel sheet to cold rolling once, or twice or more with intermediate annealing performed therebetween, to obtain a cold rolled steel sheet with a final sheet thickness; subjecting the cold rolled steel sheet to primary recrystallization annealing; applying an annealing separator to a surface of the cold rolled steel sheet after subjection to the primary recrystallization annealing; and then subjecting the cold rolled steel sheet to secondary recrystallization annealing.

2. The method of producing a grain-oriented electrical steel sheet according to 1., wherein in the chemical composition, the total amount of Sn and/or Sb is in a range of 0.020% or more and 0.300% or less in mass %.

3. The method of producing a grain-oriented electrical steel sheet according to 1. or 2., wherein the chemical composition further contains, in mass %, one or more selected from Ni in an amount of 0.005% or more and 1.5% or less, Cu in an amount of 0.005% or more and 1.5% or less, Cr in an amount of 0.005% or more and 0.1% or less, P in an amount of 0.005% or more and 0.5% or less, Mo in an amount of 0.005% or more and 0.5% or less, Ti in an amount of 0.0005% or more and 0.1% or less, Nb in an amount of 0.0005% or more and 0.1% or less, V in an amount of 0.0005% or more and 0.1% or less, B in an amount of 0.0002% or more and 0.0025% or less, Bi in an amount of 0.005% or more and 0.1% or less, Te in an amount of 0.0005% or more and 0.01% or less, and Ta in an amount of 0.0005% or more and 0.01% or less.

4. The method of producing a grain-oriented electrical steel sheet according to any one of 1. to 3., further comprising after the cold rolling, subjecting the cold rolled steel sheet to nitriding treatment.

5. The method of producing a grain-oriented electrical steel sheet according to any one of 1. to 4., wherein one or more selected from sulfide, sulfate, selenide, and selenate are added to the annealing separator.

6. The method of producing a grain-oriented electrical steel sheet according to any one of 1. to 5., further comprising after the cold rolling, subjecting the cold rolled steel sheet to magnetic domain refining treatment.

7. The method of producing a grain-oriented electrical steel sheet according to 6., wherein in the magnetic domain refining treatment, the cold rolled steel sheet after subjection to the secondary recrystallization annealing is irradiated with an electron beam.

8. The method of producing a grain-oriented electrical steel sheet according to 6., wherein in the magnetic domain refining treatment, the cold rolled steel sheet after subjection to the secondary recrystallization annealing is irradiated with a laser.

### Advantageous Effect

According to the present disclosure, by controlling the amount of N, the amount of sol.Al, the amount of Sn+Sb, and the amount of S+Se, the normal grain growth inhibiting capability is enhanced and the orientation of Goss grains growing during secondary recrystallization is sharpened, with it being possible to significantly improve the magnetic properties of the product which have been a problem with the low-temperature slab heating method. In particular, even for a thin steel sheet with a sheet thickness of 0.23 mm which has been considered difficult to increase in magnetic flux density, excellent magnetic properties, i.e. a magnetic flux density B₈ of 1.92 T or more after secondary recrystallization annealing, can be stably obtained throughout the coil length.

Moreover, in the case of further performing the nitriding treatment or adding the predetermined component(s) to the annealing separator, higher magnetic properties, i.e. a magnetic flux density B₈ of 1.94 T or more, can be obtained.

Furthermore, in the case of performing the nitriding treatment or adding the predetermined component(s) to the annealing separator, excellent iron loss properties equivalent to those of a high-temperature slab heated material, i.e. an iron loss W_{17/50} of 0.70 W/kg or less after magnetic domain refining treatment, can be obtained by the production method of low cost and high productivity according to the present disclosure.

### BRIEF DESCRIPTION OF THE DRAWINGS

In the accompanying drawings:

FIG. 1 is a graph illustrating the influence of the amount of Sn+Sb in a raw material on the magnetic flux density B₈ of a product sheet.

### DETAILED DESCRIPTION

[Chemical Composition]

A method of producing a grain-oriented electrical steel sheet according to one of the disclosed embodiments is described below. The reasons for limiting the chemical composition of steel are described first. In the description, “%” representing the content (amount) of each component element denotes “mass %” unless otherwise noted.

C in an amount of 0.002% or more and 0.080% or less

If the amount of C is less than 0.002%, the grain boundary strengthening effect by C is lost, and defects which hamper production, such as slab cracking, appear. If the amount of C is more than 0.080%, it is difficult to reduce, by decarburization annealing, the amount to 0.005% or less that causes no magnetic aging. The amount of C is therefore preferably in a range of 0.002% or more and 0.080% or less.

Si in an amount of 2.00% or more and 8.00% or less

Si is a very effective element in increasing the electrical resistance of the steel and reducing eddy current loss which constitutes part of iron loss. When adding Si to the steel sheet, the electrical resistance monotonically increases until the amount of Si reaches 11%. Once the amount of Si exceeds 8.00%, however, workability decreases significantly. If the amount of Si is less than 2.00%, the electrical resistance is low, and good iron loss properties cannot be obtained. The amount of Si is therefore in a range of 2.00% or more and 8.00% or less. The amount of Si is more preferably in a range of 2.50% or more and 4.50% or less.

Mn in an amount of 0.02% or more and 0.50% or less

Mn bonds with S or Se to form MnS or MnSe. Such MnS or MnSe, even in a minute amount, acts to inhibit normal grain growth in the heating process of secondary recrystallization annealing, in combination use with a grain boundary segregation element. If the amount of Mn is less than 0.02%, the normal grain growth inhibiting capability is insufficient. If the amount of Mn is more than 0.50%, not only high-temperature slab heating is necessary in the slab heating process before hot rolling in order to completely dissolve Mn, but also MnS or MnSe forms as a coarse precipitate, and thus the normal grain growth inhibiting capability decreases. The amount of Mn is therefore in a range of 0.02% or more and 0.50% or less.

S and/or Se in an amount of 0.005% or more and 0.010% or less in total

S and Se are one of the features of the present disclosure. As mentioned above, S and Se bond with Mn to exert the normal grain growth inhibiting action. If the total amount of S and/or Se is less than 0.005%, the normal grain growth inhibiting capability is insufficient. The total amount of S and/or Se is therefore preferably 0.005% or more. If the total amount of S and/or Se is more than 0.010%, MnS or MnSe cannot dissolve completely in the low-temperature slab heating process at 1300° C. or less which is one of the features of the present disclosure, causing insufficient normal grain growth inhibiting capability. The total amount of S and/or Se is therefore in a range of 0.005% or more and 0.010% or less.

sol.Al in an amount of 0.003% or more and less than 0.010%

Al forms a dense oxide film on the surface, and can make the control of nitriding content difficult during nitriding or hamper decarburization. Accordingly, the amount of Al is limited to less than 0.010% in sol.Al amount. Al having high oxygen affinity is, when added in a minute amount in steelmaking, expected to reduce the amount of dissolved oxygen in the steel and, for example, reduce oxide inclusions which cause degradation in properties. In view of this, the amount of sol.Al is 0.003% or more, with it being possible to suppress degradation in magnetic properties.

N in an amount of less than 0.006%

If the amount of N is excessively high, secondary recrystallization becomes difficult, as with S and Se. In particular, if the amount of N is 0.006% or more, secondary recrystallization is unlikely to occur, and the magnetic properties degrade. The amount of N is therefore limited to less than 0.006%.

At least one of Sn and Sb: Sn and/or Sb in an amount of 0.005% or more and 1.000% or less in total

Sn and Sb are one of the features of the present disclosure. Sn and Sb are grain boundary segregation elements. Adding these elements increases the normal grain growth inhibiting capability and enhances the secondary recrystallization driving force, thus stabilizing secondary recrystallization. If the total amount of Sn and/or Sb is less than 0.005%, the effect of the normal grain growth inhibiting capability is insufficient. If the total amount of Sn and/or Sb is more than 1.000%, excessive normal grain growth inhibiting capability causes unstable secondary recrystallization, leading to degradation in magnetic properties. Besides, productivity drops due to grain boundary embrittlement or rolling load increase. The total amount of Sn and/or Sb is therefore in a range of 0.005% or more and 1.000% or less. The total amount of Sn and/or Sb is more preferably in a range of 0.020% or more and 0.300% or less, in terms of magnetic property scattering reduction and productivity.

An experiment that led to limiting the amount of Sn and Sb to the above-mentioned range is described below.

Table 1 illustrates the magnetic flux density B₈ of a product sheet that varies depending on the amount of Sn+Sb. A slab with a thickness of 220 mm of each steel listed in Table 1 with the balance being Fe and inevitable impurities was heated to 1200° C., and then hot rolled to a thickness of 2.5 mm. After this, the hot rolled sheet was hot band annealed at 1000° C. for 60 s, and then cold rolled to a thickness of 0.27 mm. The cold rolled sheet was then subjected to primary recrystallization annealing at 820° C. for 100 s. The heating rate from 500° C. to 700° C. in the primary recrystallization annealing was 200° C./s. Subsequently, an annealing separator mainly composed of MgO was applied to the steel sheet surface, and then the steel sheet was subjected to secondary recrystallization annealing serving also as purification annealing at 1200° C. for 10 h. Following this, a phosphate-based insulating tension coating was applied and baked on the steel sheet, and flattening annealing was performed for the purpose of flattening the steel strip to obtain a product. Test pieces were thus obtained under the respective conditions.

TABLE 1

| | | | | | | | | | | | | Secondary | | |
|---|---|---|---|---|---|---|---|---|---|---|---|---|---|---|
| | | | | | | | | | | | | recrystallization | | |
| | Chemical composition (mass %) | | | | | | | | | | | annealed sheet | | |
| | | | | sol. | | | | | | | | B₈ | W_{17/50} | |
| No. | Si | C | Mn | Al | N | S | Se | Sn | Sb | S + Se | Sn + Sb | (T) | (W/kg) | Remarks |
| 1 | 3.41 | 0.045 | 0.07 | 0.007 | 0.003 | 0.006 | 0 | 0.002 | 0.002 | 0.006 | 0.004 | 1.857 | 0.987 | Comparative |
| | | | | | | | | | | | | | | Example |
| 2 | 3.38 | 0.041 | 0.08 | 0.008 | 0.004 | 0.001 | 0.007 | 0.000 | 0.015 | 0.008 | 0.015 | 1.891 | 0.902 | Example |
| 3 | 3.43 | 0.043 | 0.08 | 0.008 | 0.004 | 0.009 | 0.001 | 0.003 | 0.025 | 0.010 | 0.028 | 1.903 | 0.888 | Example |
| 4 | 3.36 | 0.046 | 0.09 | 0.008 | 0.004 | 0.002 | 0.001 | 0.002 | 0.033 | 0.003 | 0.035 | 1.867 | 0.938 | Comparative |
| | | | | | | | | | | | | | | Example |
| 5 | 3.40 | 0.052 | 0.07 | 0.007 | 0.005 | 0.005 | 0.003 | 0.036 | 0.002 | 0.008 | 0.038 | 1.904 | 0.883 | Example |
| 6 | 3.41 | 0.042 | 0.08 | 0.007 | 0.004 | 0.005 | 0.003 | 0.002 | 0.048 | 0.008 | 0.050 | 1.911 | 0.872 | Example |
| 7 | 3.44 | 0.049 | 0.08 | 0.009 | 0.004 | 0.002 | 0.001 | 0.002 | 0.051 | 0.003 | 0.053 | 1.869 | 0.936 | Comparative |
| | | | | | | | | | | | | | | Example |
| 8 | 3.39 | 0.034 | 0.08 | 0.007 | 0.005 | 0.006 | 0.001 | 0.003 | 0.077 | 0.007 | 0.080 | 1.917 | 0.859 | Example |
| 9 | 3.43 | 0.044 | 0.09 | 0.008 | 0.004 | 0.011 | 0.001 | 0.002 | 0.079 | 0.012 | 0.081 | 1.544 | 2.439 | Comparative |
| | | | | | | | | | | | | | | Example |
| 10 | 3.38 | 0.041 | 0.08 | 0.006 | 0.004 | 0.002 | 0.004 | 0.062 | 0.077 | 0.006 | 0.139 | 1.919 | 0.851 | Example |
| 11 | 3.37 | 0.052 | 0.09 | 0.009 | 0.004 | 0.003 | 0.001 | 0.150 | 0.076 | 0.004 | 0.226 | 1.859 | 0.966 | Comparative |
| | | | | | | | | | | | | | | Example |
| 12 | 3.42 | 0.055 | 0.09 | 0.009 | 0.005 | 0.006 | 0 | 0.150 | 0.083 | 0.006 | 0.233 | 1.917 | 0.855 | Example |
| 13 | 3.36 | 0.048 | 0.08 | 0.008 | 0.004 | 0.002 | 0.010 | 0.160 | 0.079 | 0.012 | 0.239 | 1.706 | 1.824 | Comparative |
| | | | | | | | | | | | | | | Example |
| 14 | 3.40 | 0.033 | 0.08 | 0.008 | 0.003 | 0.005 | 0.003 | 0.350 | 0.110 | 0.008 | 0.460 | 1.896 | 0.916 | Example |
| 15 | 3.38 | 0.035 | 0.07 | 0.008 | 0.004 | 0.002 | 0.002 | 0.370 | 0.200 | 0.004 | 0.570 | 1.853 | 0.960 | Comparative |
| | | | | | | | | | | | | | | Example |
| 16 | 3.29 | 0.044 | 0.08 | 0.003 | 0.004 | 0.006 | 0.002 | 0.005 | 0.005 | 0.008 | 0.010 | 1.884 | 0.918 | Example |
| 17 | 3.44 | 0.049 | 0.08 | 0.004 | 0.005 | 0.006 | 0.001 | 0.001 | 0.024 | 0.007 | 0.025 | 1.911 | 0.870 | Example |
| 18 | 3.41 | 0.049 | 0.07 | 0.008 | 0.004 | 0.004 | 0.001 | 0.500 | 0.100 | 0.005 | 0.600 | 1.892 | 0.945 | Example |
| 19 | 3.40 | 0.050 | 0.08 | 0.007 | 0.004 | 0.002 | 0.007 | 0.250 | 0.050 | 0.009 | 0.300 | 1.906 | 0.889 | Example |
| 20 | 3.33 | 0.042 | 0.09 | 0.009 | 0.004 | 0.002 | 0.006 | 0.003 | 0.002 | 0.008 | 0.005 | 1.883 | 0.935 | Example |
| 21 | 3.36 | 0.039 | 0.09 | 0.009 | 0.004 | 0.006 | 0.001 | 0.750 | 0.250 | 0.007 | 1.000 | 1.882 | 0.931 | Example |
| 22 | 3.35 | 0.045 | 0.08 | 0.008 | 0.004 | 0.007 | 0.002 | 0.750 | 0.350 | 0.009 | 1.100 | 1.872 | 0.975 | Comparative |
| | | | | | | | | | | | | | | Example |
| 23 | 3.39 | 0.051 | 0.08 | 0.007 | 0.005 | 0 | 0.006 | 0.011 | 0 | 0.006 | 0.011 | 1.894 | 0.944 | Example |
| 24 | 3.45 | 0.049 | 0.09 | 0.009 | 0.004 | 0.002 | 0.005 | 0 | 0.013 | 0.007 | 0.013 | 1.882 | 0.934 | Example |
| 25 | 3.42 | 0.048 | 0.09 | 0.009 | 0.004 | 0.001 | 0.004 | 0.014 | 0 | 0.005 | 0.014 | 1.885 | 0.917 | Example |

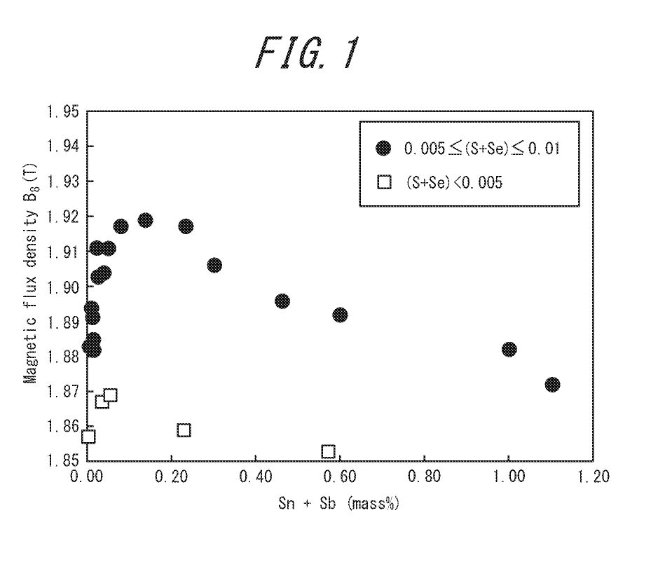

FIG. 1 illustrates the results of examining the influence of the amount of Sn+Sb (the total amount of Sn and Sb) in the raw material on the magnetic flux density B₈ of the product sheet. As illustrated in FIG. 1, by appropriately limiting the amount of Sn+Sb in the raw material while setting S and/or Se to 0.005% or more and 0.010% or less in total, the magnetic flux density was improved. In particular, by limiting the total amount of Sn and/or Sb to 0.005% or more and 1.000% or less, a magnetic flux density B₈ of 1.88 T or more was obtained. Moreover, by limiting the total amount of Sn and/or Sb to 0.020% or more and 0.300% or less, a magnetic flux density B₈ of 1.900 T or more was obtained.

The reasons why the magnetic flux density of the product sheet was improved by appropriately limiting the amount of Sn+Sb in the raw material while setting S and/or Se to 0.005% or more and 0.010% or less in total are not exactly clear, but we consider the reasons as follows. S and Se, by combined use of the grain boundary segregation effect by solute S and Se content and the precipitates such as MnS and MnSe or Cu₂S and Cu₂Se, can enhance the normal grain growth inhibiting effect and sharpen the orientation of Goss grains growing during secondary recrystallization, so that the magnetic properties of the product which have been a problem with the low-temperature slab heating method can be improved significantly. Moreover, Sn and Sb are known as grain boundary segregation elements, and contribute to the normal grain growth inhibiting capability. Furthermore, in the case where a large amount of S and/or Se is contained as in the present disclosure, the solute amount of S and/or Se increases in addition to the precipitate amount of sulfide and selenide. An increase in the solute amount of S and/or Se leads to an increase in the grain boundary segregation amount of S and/or Se. This creates a state (i.e. co-segregation) in which the grain boundary segregation of Sn and Sb is facilitated, as a result of which the effect of grain boundary segregation increases.

The basic components according to the present disclosure have been described above. The balance other than the above-mentioned components is Fe and inevitable impurities. In the present disclosure, the following elements may also be optionally added as appropriate.

Ni in an amount of 0.005% or more and 1.5% or less

Ni is an austenite forming element, and accordingly is a useful element in improving the texture of the hot rolled sheet and improving the magnetic properties through austenite transformation. If the amount of Ni is less than 0.005%, the effect of improving the magnetic properties is low. If the amount of Ni is more than 1.5%, workability decreases, and so sheet passing performance decreases. Besides, secondary recrystallization becomes unstable, which causes degradation in magnetic properties. The amount of Ni is therefore in a range of 0.005% to 1.5%.

Cu in an amount of 0.005% or more and 1.5% or less, Cr in an amount of 0.005% or more and 0.1% or less, P in an amount of 0.005% or more and 0.5% or less, Mo in an amount of 0.005% or more and 0.5% or less, Ti in an amount of 0.0005% or more and 0.1% or less, Nb in an amount of 0.0005% or more and 0.1% or less, V in an amount of 0.0005% or more and 0.1% or less, B in an amount of 0.0002% or more and 0.0025% or less, Bi in an amount of 0.005% or more and 0.1% or less, Te in an amount of 0.0005% or more and 0.01% or less, Ta in an amount of 0.0005% or more and 0.01% or less

Cu, Cr, P, Mo, Ti, Nb, V, B, Bi, Te, and Ta are each a useful element in magnetic property improvement. If the content is less than the lower limit of the corresponding range mentioned above, the magnetic property improving effect is low. If the content is more than the upper limit of the corresponding range mentioned above, secondary recrystallization becomes unstable, which causes degradation in magnetic properties. Accordingly, in the case of adding any of these elements, the amount of Cu is in a range of 0.005% or more and 1.5% or less, the amount of Cr is in a range of 0.005% or more and 0.1% or less, the amount of P is in a range of 0.005% or more and 0.5% or less, the amount of Mo is in a range of 0.005% or more and 0.5% or less, the amount of Ti is in a range of 0.0005% or more and 0.1% or less, the amount of Nb is in a range of 0.0005% or more and 0.1% or less, the amount of V is in a range of 0.0005% or more and 0.1% or less, the amount of B is in a range of 0.0002% or more and 0.0025% or less, the amount of Bi is in a range of 0.005% or more and 0.1% or less, the amount of Te is in a range of 0.0005% or more and 0.01% or less, and the amount of Ta is in a range of 0.0005% or more and 0.01% or less.

The present disclosure provides a method that combines a minute amount of precipitate and a grain boundary segregation element, which can be referred to as subtle inhibition control (SIC) method. The SIC method is more advantageous than the conventional inhibitor technique or inhibitorless technique, as it can simultaneously achieve the low-temperature slab heating and the normal grain growth inhibiting effect.

It is considered that, in the case of being redissolved in the slab heating, S and Se precipitate as fine MnS and MnSe during hot rolling, and contribute to enhanced normal grain growth inhibiting capability. If the total amount of S and/or Se is less than 0.005%, this effect is insufficient, so that the magnetic property improving effect cannot be achieved. If the total amount of S and/or Se is more than 0.010%, the redissolution in the low-temperature slab heating at 1300° C. or less is insufficient, and the normal grain growth inhibiting capability decreases rapidly. This causes a secondary recrystallization failure.

A production method according to the present disclosure is described below.

### [Heating]

A steel slab having the above-mentioned chemical composition is subjected to slab heating. The slab heating temperature is 1300° C. or less. Heating at more than 1300° C. requires the use of not ordinary gas heating but a special heating furnace such as induction heating, and so is disadvantageous in terms of cost, productivity, yield rate, and the like.

[Hot Rolling]

After this, hot rolling is performed. The hot rolling conditions are, for example, a rolling reduction of 95% or more and a sheet thickness after hot rolling of 1.5 mm to 3.5 mm. The rolling finish temperature is desirably 800° C. or more. The coiling temperature after the hot rolling is desirably about 500° C. to 700° C.

[Hot Band Annealing]

After the hot rolling, hot band annealing is optionally performed to improve the texture of the hot rolled sheet. The hot band annealing is preferably performed under the conditions of a soaking temperature of 800° C. or more and 1200° C. or less and a soaking time of 2 s or more and 300 s or less.

If the soaking temperature in the hot band annealing is less than 800° C., the texture of the hot rolled sheet is not completely improved, and non-recrystallized parts remain, so that desired texture may be unable to be obtained. If the soaking temperature is more than 1200° C., the dissolution of AlN, MnSe, and MnS proceeds, and the inhibiting capability of the inhibitors in the secondary recrystallization process is insufficient, as a result of which secondary recrystallization is suspended. This causes degradation in magnetic properties. Accordingly, the soaking temperature in the hot band annealing is preferably 800° C. or more and 1200° C. or less.

If the soaking time is less than 2 s, non-recrystallized parts remain because of the short high-temperature holding time, so that desired texture may be unable to be obtained. If the soaking time is more than 300 s, the dissolution of AlN, MnSe, and MnS proceeds, and the above-mentioned effect of N, sol.Al, Sn+Sb, and S+Se added in minute amounts decreases, as a result of which the texture of the cold rolled sheet becomes non-uniform. This causes degradation in the magnetic properties of the secondary recrystallization annealed sheet. Accordingly, the soaking time in the hot band annealing is preferably 2 s or more and 300 s or less.

[Cold Rolling]

After the hot rolling or the hot band annealing, the steel sheet is subjected to cold rolling twice or more with intermediate annealing performed therebetween, to a final sheet thickness. In this case, the intermediate annealing is preferably performed with a soaking temperature of 800° C. or more and 1200° C. or less and a soaking time of 2 s or more and 300 s or less, for the same reasons as in the hot band annealing.

In the cold rolling, by setting the rolling reduction in final cold rolling to 80% or more and 95% or less, better texture of the primary recrystallization annealed sheet can be obtained. It is also effective to perform the rolling with the rolling temperature increased to 100° C. to 250° C., or perform aging treatment once or more in a range of 100° C. to 250° C. during the cold rolling, in terms of developing Goss texture.

[Primary Recrystallization Annealing]

After the cold rolling, the cold rolled sheet is subjected to primary recrystallization annealing preferably at a soaking temperature of 700° C. or more and 1000° C. or less. The primary recrystallization annealing may be performed in, for example, a wet hydrogen atmosphere to additionally obtain the effect of decarburization of the steel sheet. If the soaking temperature in the primary recrystallization annealing is less than 700° C., non-recrystallized parts remain, and desired texture may be unable to be obtained. If the soaking temperature is more than 1000° C., there is a possibility that the secondary recrystallization of Goss orientation grains occurs. Accordingly, the soaking temperature in the primary recrystallization annealing is preferably 700° C. or more and 1000° C. or less. In the primary recrystallization annealing, the average heating rate in a temperature range of 500° C. to 700° C. is preferably 50° C./s or more.

[Nitriding Treatment]

Further, in the present disclosure, nitriding treatment may be applied in any stage between the primary recrystallization annealing and the secondary recrystallization annealing. As the nitriding treatment, any of the known techniques such as performing gas nitriding by heat treatment in an ammonia atmosphere after the primary recrystallization annealing, performing salt bath nitriding by heat treatment in a salt bath, performing plasma nitriding, adding nitride to the annealing separator, and using a nitriding atmosphere as the secondary recrystallization annealing atmosphere, may be used.

[Secondary Recrystallization Annealing]

Subsequently, an annealing separator mainly composed of MgO is optionally applied to the steel sheet surface, and then the steel sheet is subjected to secondary recrystallization annealing. Here, one or more selected from sulfide, sulfate, selenide, and selenate may be added to the annealing separator. These additives dissolve during the secondary recrystallization annealing, and then causes sulfurizing and selenizing in the steel, to thereby provide an inhibiting effect. The annealing conditions of the secondary recrystallization annealing are not limited, and conventionally known annealing conditions may be used. By using a hydrogen atmosphere as the annealing atmosphere, the effect of purification annealing can also be achieved. Subsequently, after application of insulating coating and execution of flattening annealing, a desired grain-oriented electrical steel sheet is obtained. The production conditions in the application of insulating coating and the flattening annealing are not limited, and conventional methods may be used.

The grain-oriented electrical steel sheet produced according to the above-mentioned conditions has a very high magnetic flux density as well as low iron loss properties after the secondary recrystallization. A high magnetic flux density means that the crystal grains have preferentially grown only in the Goss orientation and its vicinity during the secondary recrystallization process. In the Goss orientation and its vicinity, the growth rate of secondary recrystallized grains is higher. Therefore, an increase in magnetic flux density indicates that the secondary recrystallized grain size is potentially coarse. This is advantageous in terms of reducing hysteresis loss, but disadvantageous in terms of reducing eddy current loss.

[Magnetic Domain Refining Treatment]

To solve such mutually contradictory phenomena against the ultimate goal of iron loss reduction, it is preferable to perform magnetic domain refining treatment. By performing appropriate magnetic domain refining treatment, the disadvantageous eddy current loss caused by the coarsening of secondary recrystallized grains is reduced, and together with the hysteresis loss reduction, significantly low iron loss properties can be obtained.

As the magnetic domain refining treatment, any known heat resistant or non-heat resistant magnetic domain refining treatment may be used. With the use of a method of irradiating the steel sheet surface after the secondary recrystallization annealing with an electron beam or a laser, the magnetic domain refining effect can spread to the inside of the steel sheet in the sheet thickness direction, and thus iron loss can be significantly reduced as compared with other magnetic domain refining treatment such as an etching method.

The other production conditions may comply with typical grain-oriented electrical steel sheet production methods.

### EXAMPLES

### Example 1

Steel slabs with a thickness of 220 mm having the respective chemical compositions listed in Table 2 were each heated to 1250° C., and then hot rolled to a thickness of 2.7 mm. After this, the hot rolled sheet was hot band annealed at 1020° C. for 60 s, and then cold rolled to a thickness of 0.27 mm. The cold rolled sheet was then subjected to primary recrystallization annealing at 840° C. for 120 s. The heating rate from 500° C. to 700° C. in the primary recrystallization annealing was 100° C./s.

Subsequently, an annealing separator mainly composed of MgO was applied to the steel sheet surface, and then the steel sheet was subjected to secondary recrystallization annealing serving also as purification annealing at 1200° C. for 10 h. Following this, a phosphate-based insulating tension coating was applied and baked on the steel sheet, and flattening annealing was performed for the purpose of flattening the steel strip, to obtain a product.

The results of examining the magnetic properties of each product obtained in this way are listed in Table 2.

TABLE 2

| | | | | | | | | | | | | | Secondary | | |
|---|---|---|---|---|---|---|---|---|---|---|---|---|---|---|---|
| | | | | | | | | | | | | | recrystallization | | |
| | Chemical composition (mass %) | | | | | | | | | | | | annealed sheet | | |
| | | | | sol. | | | | | | | | | B₈ | W_{17/50} | |
| No. | Si | C | Mn | Al | N | S | Se | Sn | Sb | Others | S + Se | Sn + Sb | (T) | (W/kg) | Remarks |
| 1 | 1.82 | 0.015 | 0.09 | 0.008 | 0.003 | 0.006 | 0 | 0 | 0.080 | | 0.006 | 0.080 | 1.866 | 1.292 | Comparative |
| | | | | | | | | | | | | | | | Example |
| 2 | 8.55 | 0.044 | 0.10 | 0.009 | 0.004 | 0.005 | 0.003 | 0.120 | 0 | | 0.008 | 0.120 | 1.810 | 0.953 | Comparative |
| | | | | | | | | | | | | | | | Example |
| 3 | 3.22 | 0.001 | 0.09 | 0.008 | 0.004 | 0.007 | 0.001 | 0.110 | 0.090 | | 0.008 | 0.200 | 1.843 | 1.229 | Comparative |
| | | | | | | | | | | | | | | | Example |
| 4 | 3.30 | 0.089 | 0.10 | 0.008 | 0.005 | 0.006 | 0 | 0.090 | 0.110 | | 0.006 | 0.200 | 1.865 | 1.155 | Comparative |
| | | | | | | | | | | | | | | | Example |
| 5 | 3.29 | 0.050 | 0.01 | 0.006 | 0.003 | 0.005 | 0 | 0.090 | 0.100 | | 0.005 | 0.190 | 1.857 | 1.132 | Comparative |
| | | | | | | | | | | | | | | | Example |
| 6 | 3.36 | 0.056 | 0.56 | 0.005 | 0.004 | 0.006 | 0.002 | 0.110 | 0.090 | | 0.008 | 0.200 | 1.826 | 1.333 | Comparative |
| | | | | | | | | | | | | | | | Example |
| 7 | 3.43 | 0.042 | 0.09 | 0.010 | 0.005 | 0.006 | 0 | 0.060 | 0.060 | | 0.006 | 0.120 | 1.638 | 2.117 | Comparative |
| | | | | | | | | | | | | | | | Example |
| 8 | 3.33 | 0.051 | 0.08 | 0.002 | 0.004 | 0.005 | 0.001 | 0.060 | 0.050 | | 0.006 | 0.110 | 1.588 | 2.430 | Comparative |
| | | | | | | | | | | | | | | | Example |
| 9 | 3.50 | 0.053 | 0.09 | 0.009 | 0.006 | 0.002 | 0.008 | 0 | 0.050 | | 0.010 | 0.050 | 1.674 | 2.005 | Comparative |
| | | | | | | | | | | | | | | | Example |
| 10 | 7.43 | 0.078 | 0.41 | 0.008 | 0.004 | 0.007 | 0.001 | 0 | 0.006 | Ni: 0.007, Bi: 0.009 | 0.008 | 0.006 | 1.902 | 0.872 | Example |
| 11 | 3.19 | 0.022 | 0.09 | 0.008 | 0.004 | 0.004 | 0.004 | 0.004 | 0.001 | Cu: 0.005, Ti: 0.011, | 0.008 | 0.005 | 1.917 | 0.946 | Example |
| | | | | | | | | | | Nb: 0.089 | | | | | |
| 12 | 2.42 | 0.033 | 0.21 | 0.009 | 0.003 | 0.008 | 0.001 | 0.001 | 0.066 | Cr: 0.006, Mo: 0.47, | 0.009 | 0.067 | 1.923 | 0.981 | Example |
| | | | | | | | | | | B: 0.0023 | | | | | |
| 13 | 3.25 | 0.051 | 0.09 | 0.008 | 0.004 | 0.007 | 0 | 0.080 | 0.001 | Cu: 0.07, Cr: 0.09, | 0.007 | 0.081 | 1.926 | 0.902 | Example |
| | | | | | | | | | | Ti: 0.0011, Bi: 0.030 | | | | | |
| 14 | 4.13 | 0.046 | 0.08 | 0.007 | 0.004 | 0.006 | 0.002 | 0.041 | 0.039 | P: 0.008, V: 0.094, | 0.008 | 0.080 | 1.920 | 0.901 | Example |
| | | | | | | | | | | Te: 0.0006, Ta: 0.009 | | | | | |
| 15 | 3.36 | 0.042 | 0.08 | 0.006 | 0.004 | 0.004 | 0.004 | 0.025 | 0.053 | Cu: 0.12, Cr: 0.053, | 0.008 | 0.078 | 1.932 | 0.911 | Example |
| | | | | | | | | | | Mo: 0.036, Ti: 0.0008, | | | | | |
| | | | | | | | | | | Nb: 0.0022 | | | | | |
| 16 | 3.88 | 0.053 | 0.09 | 0.008 | 0.003 | 0.002 | 0.006 | 0.071 | 0.001 | Mo: 0.007, V: 0.0006, | 0.008 | 0.072 | 1.933 | 0.909 | Example |
| | | | | | | | | | | Bi: 0.095 | | | | | |
| 17 | 4.40 | 0.048 | 0.07 | 0.008 | 0.004 | 0.006 | 0 | 0.044 | 0.060 | Ni: 1.3, Cu: 1.4, | 0.006 | 0.104 | 1.924 | 0.890 | Example |
| | | | | | | | | | | Nb: 0.006, B: 0.0003 | | | | | |
| 18 | 3.52 | 0.030 | 0.08 | 0.007 | 0.004 | 0.006 | 0.001 | 0.001 | 0.071 | Cu: 0.09, Cr: 0.048, | 0.007 | 0.072 | 1.926 | 0.924 | Example |
| | | | | | | | | | | P: 0.067, Mo: 0.013, | | | | | |
| | | | | | | | | | | Ti: 0.0014 | | | | | |
| 19 | 3.44 | 0.049 | 0.16 | 0.009 | 0.004 | 0.005 | 0.004 | 0.001 | 0.052 | Cu: 0.11, Cr: 0.098, | 0.009 | 0.053 | 1.935 | 0.897 | Example |
| | | | | | | | | | | Mo: 0.025, B: 0.0012, | | | | | |
| | | | | | | | | | | Te: 0.094 | | | | | |
| 20 | 3.11 | 0.062 | 0.03 | 0.006 | 0.003 | 0.002 | 0.007 | 0.160 | 0.077 | Ni: 0.13, P: 0.45, | 0.009 | 0.237 | 1.927 | 0.929 | Example |
| | | | | | | | | | | Ti: 0.096, Ta: 0.0006 | | | | | |
| 21 | 3.28 | 0.004 | 0.12 | 0.007 | 0.004 | 0.002 | 0.006 | 0.110 | 0.120 | P: 0.022, Ti: 0.0011, | 0.008 | 0.230 | 1.925 | 0.911 | Example |
| | | | | | | | | | | V: 0.014, Te: 0.008 | | | | | |
| 22 | 3.39 | 0.040 | 0.11 | 0.008 | 0.004 | 0.005 | 0.003 | 0.160 | 0.092 | Mo: 0.067, Nb: 0.0034, | 0.008 | 0.252 | 1.937 | 0.909 | Example |
| | | | | | | | | | | Ta: 0.0077 | | | | | |
| 23 | 3.70 | 0.057 | 0.10 | 0.009 | 0.004 | 0.004 | 0.001 | 0.220 | 0.100 | Ni: 0.22, Cu: 0.12, | 0.005 | 0.320 | 1.912 | 0.928 | Example |
| | | | | | | | | | | Mo: 0.078, Ti: 0.0017 | | | | | |
| 24 | 3.19 | 0.041 | 0.08 | 0.006 | 0.004 | 0.006 | 0 | 0.360 | 0.210 | Cr: 0.09, Ti: 0.0009, | 0.006 | 0.570 | 1.905 | 0.967 | Example |
| | | | | | | | | | | Bi: 0.022 | | | | | |

As shown in Table 2, by appropriately limiting the amount of Sn+Sb in the raw material while setting S and/or Se to 0.005% or more and 0.010% or less in total, the magnetic flux density was improved. In particular, by limiting the total amount of Sn and/or Sb to 0.005% or more and 1.000% or less, a magnetic flux density B₈ of 1.900 T or more was obtained. Moreover, by limiting the total amount of Sn and/or Sb to 0.020% or more and 0.300% or less, a magnetic flux density B₈ of 1.920 T or more was obtained.

### Example 2

The steel slabs of Nos. 13 and 18 in Table 2 were each heated to 1230° C., and then hot rolled to a thickness of 2.7 mm. The hot rolled sheet was then hot band annealed at 1000° C. for 60 s, and subsequently subjected to the first cold rolling to an intermediate thickness of 2.0 mm. After intermediate annealing at 1040° C. for 60 s, the steel sheet was subjected to the second cold rolling to a thickness of 0.23 mm. The cold rolled sheet was then subjected to primary recrystallization annealing at 820° C. for 120 s. The heating rate from 500° C. to 700° C. in the primary recrystallization annealing was 150° C./s. Following this, the nitriding treatment and the addition of sulfate to the annealing separator were examined under the conditions listed in Table 3. As the nitriding treatment, gas nitriding treatment was performed on the primary recrystallization annealed sheet at 750° C. for 30 s and at 950° C. for 30 s in a gas atmosphere containing ammonia. The amount of nitrogen in the steel sheet after subjection to the nitriding treatment is listed in Table 3. As the addition of sulfate to the annealing separator, an annealing separator containing MgO and MgSO₄ in an amount of 10 parts by mass with respect to MgO in an amount of 100 parts by mass was applied to the steel sheet surface. After this, the steel sheet was subjected to secondary recrystallization annealing also serving as purification annealing at 1180° C. for 50 h. Subsequently, a phosphate-based insulation tension coating was applied and baked on the steel sheet, and flattening annealing was performed for the purpose of flattening the steel strip, to obtain a product sheet.

The results of examining the magnetic properties of each product sheet obtained in this way are listed in Table 3.

TABLE 3

| | | | | Secondary | | |
|---|---|---|---|---|---|---|
| | | | | recrystallization | | |
| | | Nitrided | | annealed sheet | | |
| | | sheet N | | B₈ | W_{17/50} | |
| ID | Nitriding treatment | (mass %) | Annealing separator | (T) | (W/kg) | Remarks |
| 13-a | None | 0.004 | 100: MgO | 1.921 | 0.840 | Example |
| 13-b | | 0.004 | 100: MgO + 10: MgSO₄ | 1.941 | 0.807 | Example |
| 13-c | 750° C. × 30 s | 0.023 | 100: MgO | 1.943 | 0.811 | Example |
| 13-d | | 0.025 | 100: MgO + 10: MgSO₄ | 1.947 | 0.798 | Example |
| 13-e | 950° C. × 30 s | 0.027 | 100: MgO | 1.942 | 0.809 | Example |
| 13-f | | 0.025 | 100: MgO + 10: MgSO₄ | 1.947 | 0.800 | Example |
| 18-a | None | 0.004 | 100: MgO | 1.922 | 0.829 | Example |
| 18-b | | 0.004 | 100: MgO + 10: MgSO₄ | 1.942 | 0.782 | Example |
| 18-c | 750° C. × 30 s | 0.022 | 100: MgO | 1.940 | 0.784 | Example |
| 18-d | | 0.024 | 100: MgO + 10: MgSO₄ | 1.944 | 0.776 | Example |
| 18-e | 950° C. × 30 s | 0.025 | 100: MgO | 1.941 | 0.779 | Example |
| 18-f | | 0.026 | 100: MgO + 10: MgSO₄ | 1.945 | 0.775 | Example |

As shown in Table 3, by limiting the total amount of S and/or Se to 0.005% or more and 0.010% or less and the total amount of Sn and/or Sb to 0.020% or more and 0.300% or less, a magnetic flux density B₈ of 1.920 T or more was obtained. In addition, by performing the nitriding treatment on the primary recrystallization annealed sheet or adding sulfate to the annealing separator, a magnetic flux density B₈ of 1.940 T or more was obtained.

### Example 3

For the samples of Nos. 13-b, 13-c, 18-b, and 18-c in Table 3, an experiment for determining the effect of magnetic domain refining treatment listed in Table 5 was conducted. Etching was performed to form grooves of 80 μm in width, 15 μm in depth, and 5 mm in rolling direction interval in the direction orthogonal to the rolling direction on one surface of the cold rolled steel sheet. An electron beam was continuously applied to one surface of the steel sheet after subjection to the flattening annealing in the direction orthogonal to the rolling direction, under the conditions of an acceleration voltage of 80 kV, an irradiation interval of 5 mm, and a beam current of 3 mA. A continuous laser was continuously applied to one surface of the steel sheet after subjection to the flattening annealing in the direction orthogonal to the rolling direction, under the conditions of a beam diameter of 0.3 mm, a power of 200 W, a scanning rate of 100 m/s, and an irradiation interval of 5 mm.

The results of examining the magnetic properties of each product obtained in this way are listed in Table 4.

TABLE 4

| | | | | | Secondary | | |
|---|---|---|---|---|---|---|---|
| | | | | | recrystallization | | |
| | | Nitrided | | | annealed sheet | | |
| | | sheet N | | Magnetic domain | B₈ | W_{17/50} | |
| ID | Nitriding treatment | (mass %) | Annealing separator | refining treatment | (T) | (W/kg) | Remarks |
| 13-b | None | 0.004 | 100: MgO + 10: MgSO₄ | None | 1.941 | 0.807 | Example |
| 13-b-X | | 0.004 | | Etching groove | 1.914 | 0.726 | Example |
| 13-b-Y | | 0.004 | | Electron beam | 1.940 | 0.698 | Example |
| 13-b-Z | | 0.004 | | Continuous laser | 1.939 | 0.697 | Example |
| 13-c | 750° C. × 30 s | 0.023 | 100: MgO | None | 1.943 | 0.811 | Example |
| 13-c-X | | 0.025 | | Etching groove | 1.913 | 0.724 | Example |
| 13-c-Y | | 0.023 | | Electron beam | 1.942 | 0.700 | Example |
| 13-c-Z | | 0.024 | | Continuous laser | 1.942 | 0.699 | Example |
| 18-b | None | 0.004 | 100: MgO + 10: MgSO₄ | None | 1.942 | 0.782 | Example |
| 18-b-X | | 0.004 | | Etching groove | 1.909 | 0.704 | Example |
| 18-b-Y | | 0.004 | | Electron beam | 1.941 | 0.684 | Example |
| 18-b-Z | | 0.004 | | Continuous laser | 1.941 | 0.688 | Example |
| 18-c | 750° C. × 30 s | 0.022 | 100: MgO | None | 1.940 | 0.784 | Example |
| 18-c-X | | 0.025 | | Etching groove | 1.907 | 0.702 | Example |
| 18-c-Y | | 0.023 | | Electron beam | 1.939 | 0.685 | Example |
| 18-c-Z | | 0.024 | | Continuous laser | 1.938 | 0.689 | Example |

As shown in Table 4, by performing the magnetic domain refining treatment, better iron loss properties were obtained. In detail, excellent iron loss properties equivalent to those of a high-temperature slab heated material, i.e. an iron loss W_{17/50} of 0.70 W/kg or less after the magnetic domain refining treatment by an electron beam or a continuous laser, can be obtained by the production method of low cost and high productivity according to the present disclosure.

### INDUSTRIAL APPLICABILITY

According to the present disclosure, by controlling minute amount inhibitors, the normal grain growth inhibiting capability is enhanced and the orientation of Goss grains growing during secondary recrystallization is sharpened, with it being possible to significantly improve the magnetic properties of the product which have been a problem with the low-temperature slab heating method. In particular, even for a thin steel sheet with a sheet thickness of 0.23 mm which has been considered difficult to increase in magnetic flux density, excellent magnetic properties, i.e. a magnetic flux density B_{g} of 1.92 T or more after secondary recrystallization annealing, can be stably obtained throughout the coil length.

1.-8. (canceled)

9. A method of producing a grain-oriented electrical steel sheet, the method comprising:
heating a steel slab at 1300° C. or less, the steel slab having a chemical composition containing, in mass %,
C in an amount of 0.002% or more and 0.080% or less,
Si in an amount of 2.00% or more and 8.00% or less,
Mn in an amount of 0.02% or more and 0.50% or less,
acid-soluble Al in an amount of 0.003% or more and less than 0.010%,
S and/or Se in an amount of 0.005% or more and 0.010% or less in total,
Sn and/or Sb in an amount of 0.005% or more and 1.000% or less in total,
N in an amount of less than 0.006%, and
a balance being Fe and inevitable impurities;
subjecting the steel slab to hot rolling to obtain a hot rolled steel sheet;
subjecting the hot rolled steel sheet to cold rolling once, or twice or more with intermediate annealing performed therebetween, to obtain a cold rolled steel sheet with a final sheet thickness;
subjecting the cold rolled steel sheet to primary recrystallization annealing;
applying an annealing separator to a surface of the cold rolled steel sheet after subjection to the primary recrystallization annealing; and
then subjecting the cold rolled steel sheet to secondary recrystallization annealing.

10. The method of producing a grain-oriented electrical steel sheet according to claim 9,
wherein in the chemical composition, the total amount of Sn and/or Sb is in a range of 0.020% or more and 0.300% or less in mass %.

11. The method of producing a grain-oriented electrical steel sheet according to claim 9,
wherein the chemical composition further contains, in mass %, one or more selected from
Ni in an amount of 0.005% or more and 1.5% or less,
Cu in an amount of 0.005% or more and 1.5% or less,
Cr in an amount of 0.005% or more and 0.1% or less,
P in an amount of 0.005% or more and 0.5% or less,
Mo in an amount of 0.005% or more and 0.5% or less,
Ti in an amount of 0.0005% or more and 0.1% or less,
Nb in an amount of 0.0005% or more and 0.1% or less,
V in an amount of 0.0005% or more and 0.1% or less,
B in an amount of 0.0002% or more and 0.0025% or less,
Bi in an amount of 0.005% or more and 0.1% or less,
Te in an amount of 0.0005% or more and 0.01% or less, and
Ta in an amount of 0.0005% or more and 0.01% or less.

12. The method of producing a grain-oriented electrical steel sheet according to claim 10,
wherein the chemical composition further contains, in mass %, one or more selected from
Ni in an amount of 0.005% or more and 1.5% or less,
Cu in an amount of 0.005% or more and 1.5% or less,
Cr in an amount of 0.005% or more and 0.1% or less,
P in an amount of 0.005% or more and 0.5% or less,
Mo in an amount of 0.005% or more and 0.5% or less,
Ti in an amount of 0.0005% or more and 0.1% or less,
Nb in an amount of 0.0005% or more and 0.1% or less,
V in an amount of 0.0005% or more and 0.1% or less,
B in an amount of 0.0002% or more and 0.0025% or less,
Bi in an amount of 0.005% or more and 0.1% or less,
Te in an amount of 0.0005% or more and 0.01% or less, and
Ta in an amount of 0.0005% or more and 0.01% or less.

13. The method of producing a grain-oriented electrical steel sheet according to claim 9, further comprising
after the cold rolling, subjecting the cold rolled steel sheet to nitriding treatment.

14. The method of producing a grain-oriented electrical steel sheet according to claim 10, further comprising
after the cold rolling, subjecting the cold rolled steel sheet to nitriding treatment.

15. The method of producing a grain-oriented electrical steel sheet according to claim 11, further comprising
after the cold rolling, subjecting the cold rolled steel sheet to nitriding treatment.

16. The method of producing a grain-oriented electrical steel sheet according to claim 12, further comprising
after the cold rolling, subjecting the cold rolled steel sheet to nitriding treatment.

17. The method of producing a grain-oriented electrical steel sheet according to claim 9,
wherein one or more selected from sulfide, sulfate, selenide, and selenate are added to the annealing separator.

18. The method of producing a grain-oriented electrical steel sheet according to claim 10,
wherein one or more selected from sulfide, sulfate, selenide, and selenate are added to the annealing separator.

19. The method of producing a grain-oriented electrical steel sheet according to claim 11,
wherein one or more selected from sulfide, sulfate, selenide, and selenate are added to the annealing separator.

20. The method of producing a grain-oriented electrical steel sheet according to claim 12,
wherein one or more selected from sulfide, sulfate, selenide, and selenate are added to the annealing separator.

21. The method of producing a grain-oriented electrical steel sheet according to claim 9, further comprising
after the cold rolling, subjecting the cold rolled steel sheet to magnetic domain refining treatment.

22. The method of producing a grain-oriented electrical steel sheet according to claim 10, further comprising
after the cold rolling, subjecting the cold rolled steel sheet to magnetic domain refining treatment.

23. The method of producing a grain-oriented electrical steel sheet according to claim 11, further comprising
after the cold rolling, subjecting the cold rolled steel sheet to magnetic domain refining treatment.

24. The method of producing a grain-oriented electrical steel sheet according to claim 12, further comprising
after the cold rolling, subjecting the cold rolled steel sheet to magnetic domain refining treatment.

25. The method of producing a grain-oriented electrical steel sheet according to claim 23,
wherein in the magnetic domain refining treatment, the cold rolled steel sheet after subjection to the secondary recrystallization annealing is irradiated with an electron beam.

26. The method of producing a grain-oriented electrical steel sheet according to claim 24,
wherein in the magnetic domain refining treatment, the cold rolled steel sheet after subjection to the secondary recrystallization annealing is irradiated with an electron beam.

27. The method of producing a grain-oriented electrical steel sheet according to claim 23,
wherein in the magnetic domain refining treatment, the cold rolled steel sheet after subjection to the secondary recrystallization annealing is irradiated with a laser.

28. The method of producing a grain-oriented electrical steel sheet according to claim 24,
wherein in the magnetic domain refining treatment, the cold rolled steel sheet after subjection to the secondary recrystallization annealing is irradiated with a laser.
